(19) United States
(12) Patent Application Publication
(10) Pub. No.: US 2015/0103064 A1
(43) Pub. Date: Apr. 16, 2015

(54) METHOD OF DRIVING A DISPLAY PANEL AND DISPLAY APPARATUS PERFORMING THE SAME

(71) Applicants: Pusan National University Industry-University Cooperation Foundation, Busan (KR); Samsung Display Co., LTD., Yongin-City (KR)

(72) Inventors: Tae-Hyung HWANG, Seoul (KR); Seong-Su LIM, Seoul (KR); Jung-Wook KIM, Busan (KR); Tae-Hoon YOON, Busan (KR)

(73) Assignees: Pusan National University Industry-University Cooperation Foundation, Busan (KR); Samsung Display Co., LTD., Yongin-City (KR)

(21) Appl. No.: 14/244,569

(22) Filed: Apr. 3, 2014

(30) Foreign Application Priority Data
Oct. 15, 2013 (KR) 10-2013-0122564

(51) Int. Cl. G09G 3/20; G09G 3/36

(52) U.S. Cl. CPC G09G 3/2003; G09G 3/3648
USPC 345/212; 345/89

(57) ABSTRACT

A method of driving a display panel includes applying a common voltage and a bias voltage to two of a first electrode, a second electrode and a third electrode of the display panel to form a vertical field during a period during which the display panel displays an image, and applying a data voltage based on a grayscale of the image to one of the first and second electrodes to form an in-plane field during the period during which the display panel displays the image, where the display panel includes a first substrate including the first electrode, the second electrode which overlaps the first electrode and a transistor connected to one of the first and second electrodes, and a second substrate disposed opposite to the first substrate and including the third electrode.

This application claims priority to Korean Patent Application No. 10-2013-0122564, filed on Oct. 15, 2013, and all the benefits accruing therefrom under 35 U.S.C. §119, the content of which are incorporated by reference herein in its entirety.

### BACKGROUND

1. Field

Exemplary embodiments of the invention relate to a method of driving a display panel and a display apparatus performing the method. More particularly, exemplary embodiments of the invention relate to a method of driving a display panel for achieving a response time of a high speed and a display apparatus performing the method of driving the display panel.

2. Description of the Related Art

In general, various liquid crystal mode techniques, such as an in-plane switching (“IPS”) mode, a fringe field switching (“FFS”) mode have been developed to improve a viewing angle of a liquid crystal display. The IPS mode includes a pixel electrode and a common electrode disposed on a same surface as a surface of the pixel electrode. Thus, an electric field generated between the pixel and the common electrodes is a horizontal electric field substantially parallel to a surface of display substrate. In the IPS mode, liquid crystals are rotated in a direction substantially parallel to the surface of the display substrate, such that an anisotropic difference for a refractive index of the liquid crystals viewed by a viewer is small and liquid crystal layers having different rotation directions of the liquid crystals opposite to each other are provided in a vertical section of a display panel. Thus, the IPS mode compensates for a phase difference of light to improve the viewing angle.

The FFS mode has a similar concept to the IPS mode in that liquid crystals are aligned using a horizontal electric field. However, the FFS mode includes a pixel electrode, and a common electrode on a surface different from the surface of the pixel electrode, such that the liquid crystals are aligned using the horizontal electric field and a vertical electric field.

In the FFS mode, the liquid crystals are aligned based on the vertical electric field such that transmissivity may be increased. In the FFS mode, the viewing angle of the FFS mode is also increased as in the IPS mode, because the liquid crystals move in the horizontal direction.

### SUMMARY

Exemplary embodiments of the invention provide a method of driving a display panel for achieving a high-speed response time.

Exemplary embodiments of the invention provide a display apparatus performing the method of driving the display panel.

According to an exemplary embodiment of the invention, a method of driving a display panel includes applying a common voltage and a bias voltage to two of a first electrode, a second electrode and a third electrode of the display panel to form a vertical field during a period during which the display panel displays an image, and applying a data voltage based on a grayscale of the image to one of the first and second electrodes to form an in-plane field during the period during which the display panel displays the image, where the display panel includes a first substrate including the first electrode, the second electrode which overlaps the first electrode and a transistor connected to one of the first and second electrodes, and a second substrate disposed opposite to the first substrate and including the third electrode.

In an exemplary embodiment, the applying the common voltage and the bias voltage to two of the first electrode, the second electrode and the third electrode of the display panel may include applying the common voltage to the first electrode, and applying the bias voltage to the third electrode such that the vertical field is formed between the first and third electrodes, and the applying the data voltage based on the grayscale of the image to one of the first and second electrodes may include applying the data voltage to the second electrode such that the in-plane field is formed between the first and second electrodes.

In an exemplary embodiment, the first electrode may be a common electrode which substantially covers the first substrate.

In an exemplary embodiment, the applying the common voltage and the bias voltage to two of the first electrode, the second electrode and the third electrode of the display panel may include applying the bias voltage to the first electrode, and applying the common voltage to the third electrode such that the vertical field is formed between the first and third electrodes, and the applying the data voltage based on the grayscale of the image to one of the first and second electrodes may include applying the data voltage to the second electrode such that the in-plane field is formed between the second and third electrodes.

In an exemplary embodiment, the third electrode may be a common electrode which substantially covers the second substrate.

In an exemplary embodiment, the method may further include swinging a polarity of the data voltage every preset period based on a polarity inversion mode.

In an exemplary embodiment, the method may further include swinging a polarity of the bias voltage in synchronization with the polarity of the data voltage.

According to another exemplary embodiment of the invention, a display apparatus includes a display panel including a first substrate which includes a first electrode, a second electrode overlapping the first electrode and a transistor connected to one of the first and second electrode, a second substrate which includes a third electrode and is opposite to the first substrate a first electrode, and a liquid crystal layer disposed between the first and second substrates and a panel driving part configured to apply a common voltage and a bias voltage to two of the first, second and third electrodes to form a vertical field during a period, during which the display panel displays an image, and to apply a data voltage based on a grayscale of the image to one of the first and second electrodes to form an in-plane field during the period during which the display panel displays the image.

In an exemplary embodiment, the common voltage may be applied to the first electrode and the bias voltage is applied to the third electrode such that the vertical field is formed between the first and third electrodes, and the data voltage is applied to the second electrode such that the in-plane field is formed between the first and second electrodes

In an exemplary embodiment, the first electrode may be a common electrode which substantially covers the first substrate.

In an exemplary embodiment, the bias voltage may be applied to the first electrode and the common voltage may be to the third electrode such that the vertical field is formed between the first and third electrodes, and the data voltage may be applied to the second electrode such that the in-plane field is formed between the second and third electrodes.

In an exemplary embodiment, the third electrode may be a common electrode which substantially covers the second substrate.

In an exemplary embodiment, the panel driving part may be configured to swing a polarity of the data voltage every preset period based on a polarity inversion mode.

In an exemplary embodiment, the panel driving part may be configured to swing a polarity of the bias voltage in synchronization with the polarity of the data.

In an exemplary embodiment, the display panel may further include a first polarizing plate disposed adjacent to the first substrate and having a first polarization axis, and a second polarizing plate disposed adjacent to the second substrate and having a second polarization axis.

In an exemplary embodiment, a rubbing direction of the display panel may be different from the first and second polarization axes, and the display panel may display a white grayscale in a field-off state.

In an exemplary embodiment, the rubbing direction may be substantially parallel to a predetermined direction.

In an exemplary embodiment, a rubbing direction of the display panel may be substantially parallel to at least one of the first and second polarization axes, and the display panel displays a black grayscale in a field-off state.

In an exemplary embodiment, the rubbing direction may be sloped at an angle of about zero (0) degree to about 90 degrees from the predetermined direction.

In an exemplary embodiment, when the display panel displays a white grayscale, a longitudinal-axis direction of a liquid crystal in the liquid crystal layer may be sloped at an angle of about 45 degrees from the first and second polarization axes.

According to exemplary embodiments of the invention, the bias voltage is continually applied to the display panel such that the vertical field is formed together with the in-plane field during a period during which the display panel displays the image. Thus, the in-plane field may be formed in the vertical field such that the display panel may have a response-time of a high speed. In such embodiments, the polarity of the bias voltage swings in synchronization with the polarity of the data voltage based on the polarity inversion mode and thus, a degradation of the liquid crystal may be effectively prevented.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus, according to the invention;

FIG. 2 is a conceptual diagram illustrating an exemplary embodiment of a display panel as shown in FIG. 1;

FIG. 3 is a waveform diagram illustrating an exemplary embodiment of a method of driving the display panel shown in FIG. 1;

FIG. 4 is a conceptual diagram illustrating an exemplary embodiment of a mechanism for driving the display panel as shown in FIG. 1;

FIG. 5 is a graph diagram illustrating a response time of an exemplary embodiment of the display panel as shown in FIG. 1;

FIG. 6 is a conceptual diagram illustrating an alternative exemplary embodiment of a method of driving a display panel, according to the invention;

FIG. 7 is a conceptual diagram illustrating an exemplary embodiment of a mechanism for driving the display panel as shown in FIG. 6;

FIG. 8 is a waveform diagram illustrating an exemplary embodiment of a method of driving a display panel, according to the invention;

FIG. 9 is a conceptual diagram illustrating exemplary embodiments of a polarity inversion mode of the display panel as shown in FIG. 8;

FIG. 10 is a conceptual diagram illustrating another alternative exemplary embodiment of a method of driving a display panel, according to the invention; and

FIG. 11 is a conceptual diagram illustrating another alternative exemplary embodiment of a method of driving a display panel, according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, exemplary embodiments of the invention will be described in detail with reference to the accompanying drawings.

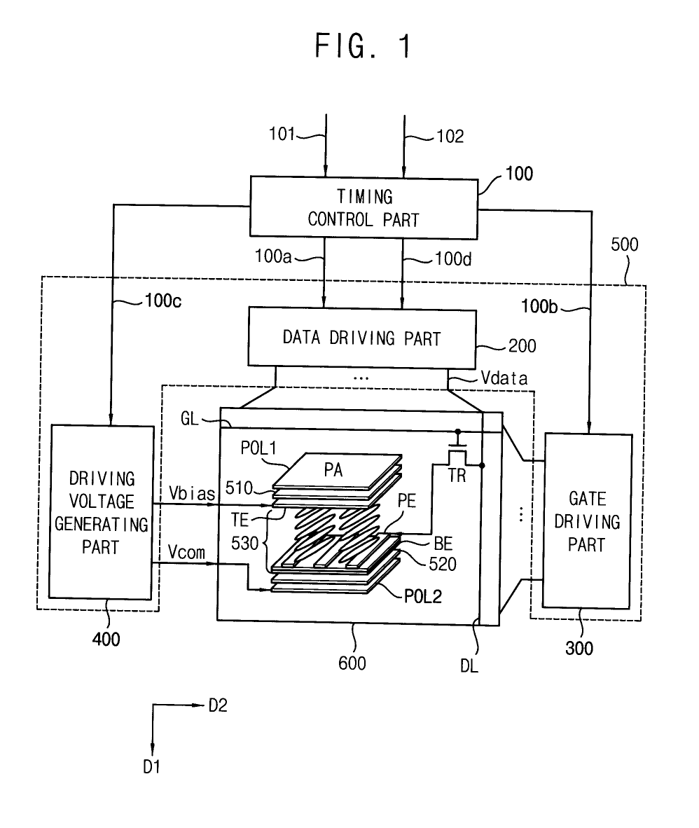

FIG. 1 is a block diagram illustrating an exemplary embodiment of a display apparatus, according to the invention.

Referring to FIG. 1, an exemplary embodiment of the display apparatus may include a timing control part 100, a panel driving part 500 and a display panel 600. The panel driving part 500 is configured to drive the display panel 600, and the panel driving part 500 includes a data driving part 200, a gate driving part 300 and a driving voltage generating part 400.

The timing control part 100 is configured to generally control an operation of the display apparatus. The timing control part 100 is configured to generate a plurality of timing control signals, e.g., a first timing control signal 100a, a second timing control signal 100b and a third timing control signal 100c, to control a driving timing of the data driving part 200, the gate driving part 300 and the driving voltage generating part 400 based on an original control signal 101. The timing control part 100 is configured to correct an original data signal 102 using various compensation algorithms and is configured to provide the data driving part 200 with a data signal 100d.

The data driving part 200 is configured to convert the data signal 110d to a data voltage using a gamma voltage and is configured to provide a data line DL of the display panel 600 with the data voltage based on the timing control signal 100a received from the timing control part 100.

The gate driving part 300 is configured to generate a gate signal and provides a gate line GL of the display panel 600 with the gate signal based on the second timing control signal 100b received from the timing control part 100.

The driving voltage generating part 400 is configured to generate a plurality of driving voltages to drive the display panel 600 based on the third timing control signal 100c received from the timing control part 100. The driving voltages may include driving voltages AVDD and DVDD that drive the data driving part 200, driving voltages VON and VOFF that drive the gate driving part 300 and driving voltages Vcom and Vbias that drive the display panel 600.

In an exemplary embodiment, as shown in FIG. 1, the driving voltage generating part 400 is configured to generate a common voltage Vcom and a bias voltage Vbias and is configured to provide the display panel 600 with the common voltage Vcom and the bias voltage Vbias. In such an embodiment, the common voltage Vcom and the bias voltage Vbias may be continually applied to the display panel 600 during a period, during which the display apparatus displays an image. The period during which the display apparatus displays the image includes a plurality of frame periods. Each of the frame periods includes an active period, during which a data voltage is applied to the display panel 600, and a vertical blanking period, during which the data voltage is not applied to the display panel 600. In such an embodiment, the bias voltage Vbias may be applied to the display panel 600 during all of the vertical blanking period and the active period.

The display panel 600 includes a first substrate 510, a second substrate 520, a liquid crystal layer 530, a first polarizing plate POL1 and a second polarizing plate POL2.

The second substrate 520 includes a first electrode (also referred to as bottom electrode) BE, a plurality of data lines DL, a plurality of gate lines GL, a plurality of transistors TR and a plurality of second electrodes (also referred to as pattern electrodes) PE.

The bottom electrode BE overlaps the pattern electrodes PE and receives the common voltage Vcom from the driving voltage generating part 400. The common voltage Vcom forms a vertical field with the bias voltage Vbias and forms an in-plane field with the data voltage Vdata.

In such an embodiment, a liquid crystal of the liquid crystal layer 530 in the vertical filed is aligned substantially vertically to the first substrate 510, and the liquid crystal in the in-plane filed is aligned substantially horizontally to the second substrate 520 such that grayscales may be displayed.

The bottom electrode BE may be disposed to overlap a plurality of pixel areas PA, which is defined on the second substrate 520, as a common electrode, or the bottom electrode BE may be separately provided in each pixel area.

The data lines DL extends substantially in a first direction D1 and are arranged substantially in a second direction D2 crossing the first direction D1. The data lines DL receives the data voltage Vdata from the data driving part 200.

The gate lines GL extends substantially in the second direction D2 and are arranged substantially in the first direction D1. The gate lines GL receives the gate signal from the gate driving part 300.

The transistors TR are connected to the data lines DL, the gate lines GL and the pattern electrodes PE. Each of the transistors TR may be disposed in an area where the data lines DL and the gate lines GL cross each other. Each of the transistors TR may be turned on in response to the gate signal applied to the gate line GL connected thereto and thereby transfers the data voltage Vdata applied to the data line DL connected thereto to the pattern electrode PE.

The pattern electrode PE may be a pixel electrode, which is separately disposed on a pixel area PA and connected to the transistor TR. The pattern electrode PE receives the data voltage Vdata when the transistor TR is turned on. The pattern electrode PE may be patterned to have a predetermined shape, e.g., a bar shape. The data voltage Vdata forms the in-plane field with the common voltage Vcom.

In one exemplary embodiment, for example, the liquid crystal is aligned substantially horizontal to the in-plane field formed by the data voltage Vdata corresponding to the grayscale of the image such that the image of the grayscale may be displayed.

The first substrate 510 includes a third electrode (also referred to as top electrode) TE. The top electrode TE receives the bias voltage Vbias from the driving voltage generating part 400. The top electrode TE may be disposed to overlap a plurality of pixel areas PA, which is defined on the second substrate 520, as the common electrode, or the top electrode TE may be separately disposed in each pixel area.

The bias voltage Vbias has a voltage level at which the liquid crystal is aligned substantially vertically to the first substrate 510.

The liquid crystal layer 530 is disposed between the first and second substrates 510 and 520. The liquid crystal layer 530 is aligned by an electric field formed between the first and second substrates 510 and 520. The liquid crystal layer 530 may include homogeneously-arranged positive liquid crystal.

In an exemplary embodiment, the display panel 600 includes a three-electrode structure which includes three electrodes such as the bottom electrode BE, the pattern electrode PE and the top electrode TE. The in-plane field and the vertical field may be formed by the three electrodes in the display panel 600. Thus, the liquid crystal of the liquid crystal layer 530 is aligned substantially vertically to the first substrate 510 by the vertical field based on the bias voltage Vbias and then the liquid crystal in a vertical alignment state is aligned substantially horizontally to the first substrate 510 by the in-plane field based on the data voltage Vdata of the grayscale in a vertical alignment state of the liquid crystal. Therefore, in such an embodiment, the liquid crystal may have a high speed response-time.

The first polarizing plate POL1 is disposed adjacent to the first substrate 510 and has a first polarization axis which polarizes light of a first optical axis.

The second polarizing plate POL2 is disposed adjacent to the second substrate 520 and has a second polarization axis which polarizes light of a second optical axis, which is perpendicular to the first optical axis.

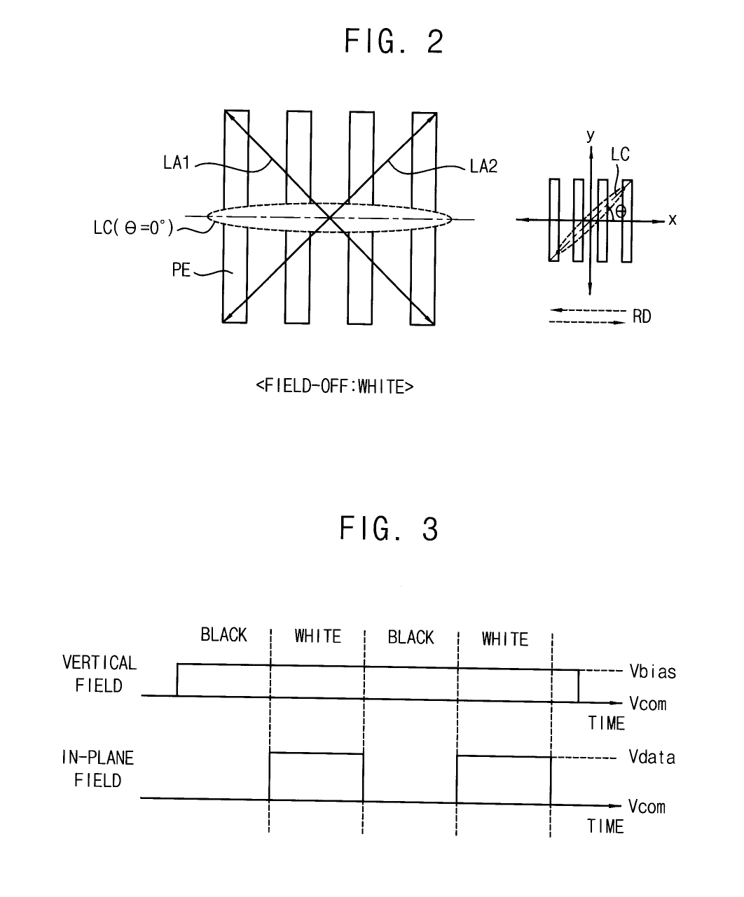

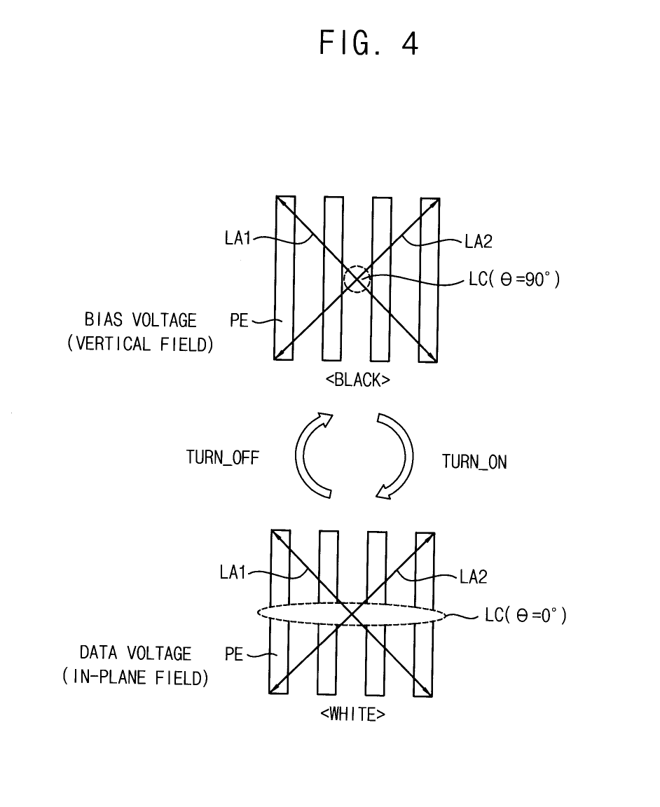

FIG. 2 is a conceptual diagram illustrating an exemplary embodiment of a display panel as shown in FIG. 1. FIG. 3 is a waveform diagram illustrating an exemplary embodiment of a method of driving the display panel as shown in FIG. 1. FIG. 4 is a conceptual diagram illustrating an exemplary embodiment of a mechanism for driving the display panel as shown in FIG. 1.

Referring to FIGS. 1 and 2, the display panel 600 has a rubbing direction RD which is different from polarization axes LA1 and LA2 of the polarizing plates.

In one exemplary embodiment, for example, as shown in FIG. 2, the rubbing direction RD of the display panel 600 is substantially parallel to a predetermined direction substantially perpendicular to the extending direction (y-axis in FIG. 2) of the bar shape of the pattern electrode PE, e.g., an x-axis, a first polarization axis LA1 of the first polarizing plate POL1 is sloped at an angle of about 135 degrees from the x-axis, and the second polarization axis LA2 of the second polarizing plate POL2 is sloped at an angle of about 45 degrees from the x-axis.

In a field-off state (FIELD-OFF), a longitudinal-axis of the liquid crystal LC is aligned along the rubbing direction RD substantially in parallel to the x-axis. In the field-off state, an angle θ between the longitudinal-axis of the liquid crystal LC and the x-axis is about zero (0) degree.

In the field-off state (FIELD-OFF), the longitudinal-axis of the liquid crystal LC is different from the first and second polarization axes LA1 and LA2 of the first and second polarizing plates POL1 and POL2 such that the display panel 600 transmits the light.

Thus, the display panel 400 displays the white (WHITE) in the field-off state (FIELD-OFF).

Referring to FIGS. 3 and 4, during a period during which the display panel 600 displays the image, the bias voltage Vbias is applied to the top electrode TE, the common voltage Vcom is applied to the bottom electrode BE, and the data voltage Vdata is applied to the pattern electrode PE that is the pixel electrode. The vertical field may be formed together with the in-plane field during the period during which the display panel 600 displays the image.

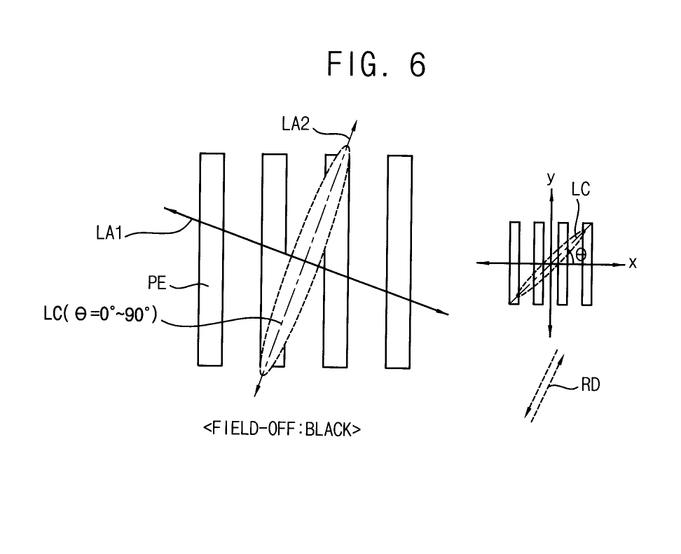

The vertical field (VERTICAL FIELD) is formed in the display panel 600 by the bias voltage Vbias and the common voltage Vcom. The liquid crystal LC having the longitudinal-axis substantially in parallel to a predetermined direction substantially perpendicular to the extending direction (y-axis in FIG. 6) of the bar shape of the pattern electrode PE, e.g., the x-axis, is aligned substantially vertically to the first and second polarization axes LA1 and LA2 of the first and second polarizing plates POL1 and POL2 by the vertical field. In the vertical field state (VERTICAL FIELD), the angle θ between the longitudinal-axis of the liquid crystal LC and the x-axis is about 90 degrees.

When the data voltage Vdata corresponding to the grayscale of the image is applied to the pattern electrode PE, the in-plane field (IN_PLANE FIELD) is formed between the bottom electrode BE and the pattern electrode PE. The liquid crystal LC aligned substantially vertically to the first and second polarization axes LA1 and LA2 of the first and second polarizing plates POL1 and POL2 is reoriented to be horizontal to the first and second polarization axes LA1 and LA2 of the first and second polarizing plates POL1 and POL2 by the in-plane field (IN_PLANE FIELD).

In one exemplary embodiment, for example, when the pattern electrode PE receives the data voltage Vdata of a white grayscale, an in-plane field intensity corresponding to the white grayscale is formed between the bottom electrode BE and the pattern electrode PE such that the liquid crystal LC aligned substantially horizontal to the first and second polarization axes LA1 and LA2 of the first and second polarizing plates POL1 and POL2 based on the in-plane field intensity may display the white grayscale.

In such an embodiment, the pattern electrode PE receives the data voltage Vdata of a middle grayscale, an in-plane field intensity corresponding to the middle grayscale is formed between the bottom electrode BE and the pattern electrode PE such that the liquid crystal LC aligned horizontally to the first and second polarization axes LA1 and LA2 of the first and second polarizing plates POL1 and POL2 based on the in-plane field intensity may display the middle grayscale.

As shown in FIG. 4, the liquid crystal LC of the display panel 600 may be aligned in a vertical field state (VERTICAL FIELD) and an in-plane field state (IN-PLANE FIELD).

In an exemplary embodiment, the vertical field is formed together with the in-plane field during the period during which the display panel 600 displays the image, and thus, an alignment time of the liquid crystal in the in-plane field may be decreased. Thus, in such an embodiment, the liquid crystal may have a high speed response-time.

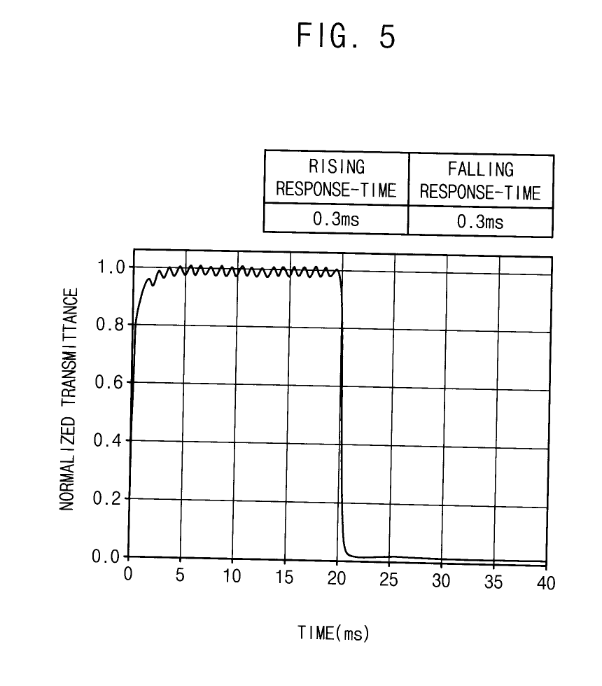

FIG. 5 is a graph diagram illustrating a response time of an exemplary embodiment of the display panel as shown in FIG. 1.

Referring to FIG. 5, in an exemplary embodiment, the display panel displays may be in a turn-on state when the display panel displays a white grayscale, and the display panel displays may be in a turn-off state when the display panel displays a black grayscale.

As shown in FIG. 5, a rising response-time of the display panel, during which the display panel is changed from the turn-off state to the turn-on state, is about 0.3 millisecond (ms). A falling response-time of the display panel, during which the display panel is changed from the Turn-on state to the Turn-off state, is about 0.3 ms.

Table 1 shows the response-time of a fringe-field switching (“FFS”) mode display panel that is an in-plane field mode having a two-electrode structure.

TABLE 1
FFS mode

| Rising response-time | Falling response-time |
|---|---|
| 24.0 ms | 21.0 ms |

Referring to Table 1, in the FFS mode display panel having the two-electrode structure, a rising response-time, during which the display panel is changed from the Turn-off state to the Turn-on state, is about 24.0 ms, and a falling response-time, during which the display panel is changed from the Turn-on state to the Turn-off state, is about 21.0 ms.

The rising response-time and the falling response-time in an exemplary embodiment of the display panel are shorter than the rising response-time and the falling response-time of the FFS mode display panel having the two-electrode structure.

In exemplary embodiments of the invention, the in-plane field is formed together with the vertical field by the three-electrode structure, and thus, the liquid crystal may have a high speed response-time.

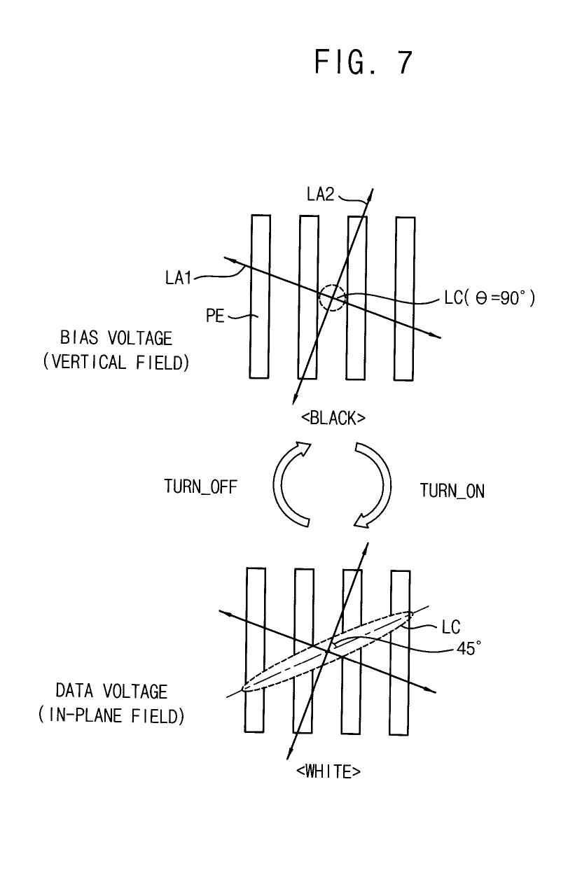

FIG. 6 is a conceptual diagram illustrating an exemplary embodiment of a method of driving a display panel, according to the invention. FIG. 7 is a conceptual diagram illustrating an exemplary embodiment of a mechanism for driving the display panel as shown in FIG. 6.

Referring to FIG. 6, the display panel 600 has a rubbing direction RD which is substantially parallel to one of the polarization axes LA1 and LA2 of the polarizing plates.

In one exemplary embodiment, for example, the rubbing direction RD is sloped at an angle of about zero (0) degree to about 90 degrees from the X-axis. The first polarization axis LA1 of the first polarizing plate POL1 or the second polarization axis LA2 of the second polarizing plate POL2 is equal to the rubbing direction RD.

In the Field-off state (FIELD-OFF), the longitudinal-axis of the liquid crystal LC is aligned along the rubbing direction RD sloped at an angle of about zero (0) degree to about 90 degrees from the X-axis. Thus, the longitudinal-axis of the liquid crystal LC is aligned along the second polarization axis LA2 substantially in parallel to the rubbing direction RD. In the Field-off state (FIELD-OFF), an angle θ between the longitudinal-axis of the liquid crystal LC and the X-axis may be about 0 degree to about 90 degrees.

In the Field-off state (FIELD-OFF), the longitudinal-axis of the liquid crystal LC is equal to at least one of the first and second polarization axes LA1 and LA2 of the first and second polarizing plates POL1 and POL2 so that the display panel 600 does not transmit the light.

Thus, the display panel 600 displays the black in the Field-off state (FIELD-OFF).

Referring to FIGS. 6 and 7, during the period during the display panel 600 displays the image, the bias voltage Vbias is applied to the top electrode TE, the common voltage Vcom is applied to the bottom electrode BE and the data voltage Vdata is applied to the pattern electrode PE that is the pixel electrode. The vertical field may be formed together with the in-plane field during the period during which the display panel 600 displays the image.

The display panel 600 forms the vertical field (VERTICAL FIELD) by the bias voltage Vbias and the common voltage Vcom. The longitudinal-axis of the liquid crystal LC is aligned vertically to the first and second polarization axes LA1 and LA2 of the first and second polarizing plates POL1 and POL2 by the vertical field (VERTICAL FIELD). Thus, the angle θ of the longitudinal-axis of the liquid crystal LC and the X-axis is about 90 degrees.

When the data voltage Vdata corresponding to the grayscale of the image is applied to the pattern electrode PE, the in-plane field (IN-PLANE FIELD) is formed between the bottom electrode BE and the pattern electrode PE. The liquid crystal LC aligned vertically to the first and second polarization axes LA1 and LA2 of the first and second polarizing plates POL1 and POL2 is aligned horizontally to the first and second polarization axes LA1 and LA2 of the first and second polarizing plates POL1 and POL2 by the in-plane field (IN-PLANE FIELD) corresponding to the data voltage Vdata.

In one exemplary embodiment, for example, when the pattern electrode PE receives the data voltage Vdata of a white grayscale, an in-plane field intensity corresponding to the white grayscale is formed between the bottom electrode BE and the pattern electrode PE such that the liquid crystal LC aligned horizontally to the first and second polarization axes LA1 and LA2 of the first and second polarizing plates POL1 and POL2 based on the in-plane field intensity may display the white grayscale

As shown in FIG. 7, the longitudinal-axis of the liquid crystal LC is aligned with a slope which is sloped at an angle of about 45 degrees from each of the first and second polarization axes LA1 and LA2. The longitudinal-axis of the liquid crystal LC is different from the first and second polarization axes LA1 and LA2 such that the display panel 600 transmits the light. Thus, the display panel 600 may display the white.

In addition, the pattern electrode PE receives the data voltage Vdata of a middle grayscale, an in-plane field intensity corresponding to the middle grayscale is formed between the bottom electrode BE and the pattern electrode PE such that the liquid crystal LC aligned horizontally to the first and second polarization axes LA1 and LA2 of the first and second polarizing plates POL1 and POL2 based on the in-plane field intensity may display the middle grayscale.

As shown in FIG. 7, the liquid crystal LC of the display panel 600 may be aligned in a vertical field state (VERTICAL FIELD) and an in-plane field state (IN-PLANE FIELD).

In an exemplary embodiment, the vertical field is formed together with the in-plane field during a period during which the display panel 600 displays the image such that an alignment time of the liquid crystal in the in-plane field may be decreased. Thus, in such an embodiment, the liquid crystal may have a high speed response-time.

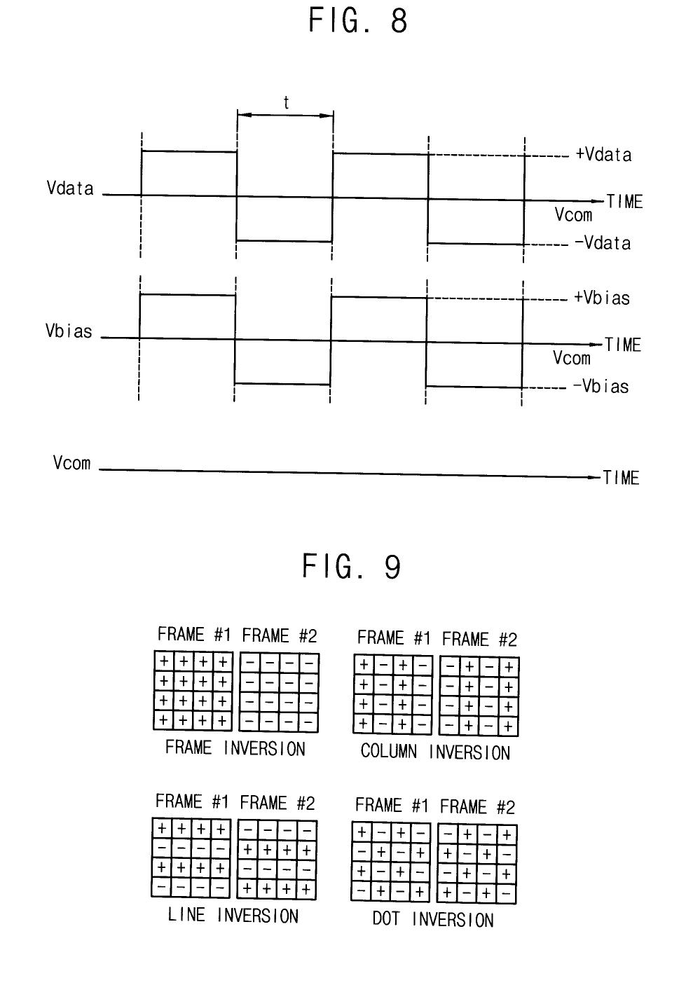

FIG. 8 is a waveform diagram illustrating an exemplary embodiment of a method of driving a display panel, according to the invention. FIG. 9 is a conceptual diagram illustrating exemplary embodiments of a polarity inversion mode of the display panel as shown in FIG. 8.

Referring to FIGS. 8 and 9, in an exemplary embodiment, a polarity of the bias voltage Vbias may swing based on a polarity of the data voltage Vdata.

In one exemplary embodiment, for example, as shown in FIG. 9, the display panel may be driven as a polarity inversion mode for effectively preventing the liquid crystal LC from being degraded. The polarity inversion mode may include a frame inversion mode, a column inversion mode, a row inversion mode and a dot inversion mode, for example.

In the frame inversion mode, date voltages of a first polarity are applied to all pixels during a current frame period and date voltages of a second polarity opposite to the first polarity are applied to the all pixels during a next frame period. In the column inversion mode, date voltages of the first polarity are applied to first column pixels and date voltages of the second polarity are applied to second column pixels adjacent to the first column pixels during the current frame period. And then, date voltages of the second polarity are applied to the first column pixels and date voltages of the first polarity are applied to the second column pixels during the next frame period. In the row inversion mode, date voltages of the first polarity are applied to first row pixels and date voltages of the second polarity are applied to second row pixels adjacent to the first row pixels during the current frame period. And then, date voltages of the second polarity are applied to the first row pixels and date voltages of the first polarity are applied to the second row pixels during the next frame period. In the dot inversion mode, a date voltage of the first polarity is applied to a first pixel and a date voltage of the second polarity is applied to a second pixel adjacent to the first pixel during the current frame period. And then, date voltage of the second polarity is applied to the first pixel and date voltage of the first polarity is applied to the second pixel during the next frame period.

As described above, the polarity of the data voltage Vdata swings every preset period based on, e.g., in synchronization with, the polarity inversion mode.

In an exemplary embodiment, the polarity of the bias voltage Vbias swings in synchronization with the polarity of the data voltage Vdata. Thus, the polarity of the bias voltage Vbias is the same as the polarity of the data voltage Vdata.

As shown in FIG. 8, the display panel receives the data voltage +Vdata of a positive polarity and the data voltage −Vdata of a negative polarity opposite to the positive polarity with respect to a reference voltage. The data voltage Vdata has the polarity which swings every preset period (t). The reference voltage of the data voltage Vdata may be the common voltage Vcom.

In synchronization with the polarity of the data voltage Vdata, the bias voltage Vbias having the polarity, which is the same as the polarity of the data voltage Vdata, is applied to the display panel. The bias voltage Vbias includes a bias voltage +Vbias of the positive polarity and a bias voltage −Vbias of the negative polarity opposite to the positive polarity with respect to the reference voltage. The reference voltage of the bias voltage Vbias may be the common voltage Vcom.

In one exemplary embodiment, for example, when the data voltage +Vdata of the positive polarity is applied to the pixel, the bias voltage +Vbias of the positive polarity is applied to the pixel. When the data voltage −Vdata of the negative polarity is applied to the pixel, the bias voltage −Vbias of the negative polarity is applied to the pixel.

In an exemplary embodiment, when the data voltage +Vdata of the positive polarity is applied to the pattern electrode PE of the pixel, the bias voltage +Vbias of the positive polarity is applied to the top electrode TE that overlaps the pattern electrode PE. When the data voltage −Vdata of the negative polarity is applied to the pattern electrode PE of the pixel, the bias voltage −Vbias of the negative polarity is applied to the top electrode TE that overlaps the pattern electrode PE.

Therefore, a polarity inversion mode of the bias voltage Vbias may effectively prevent the liquid crystal LC from being degraded.

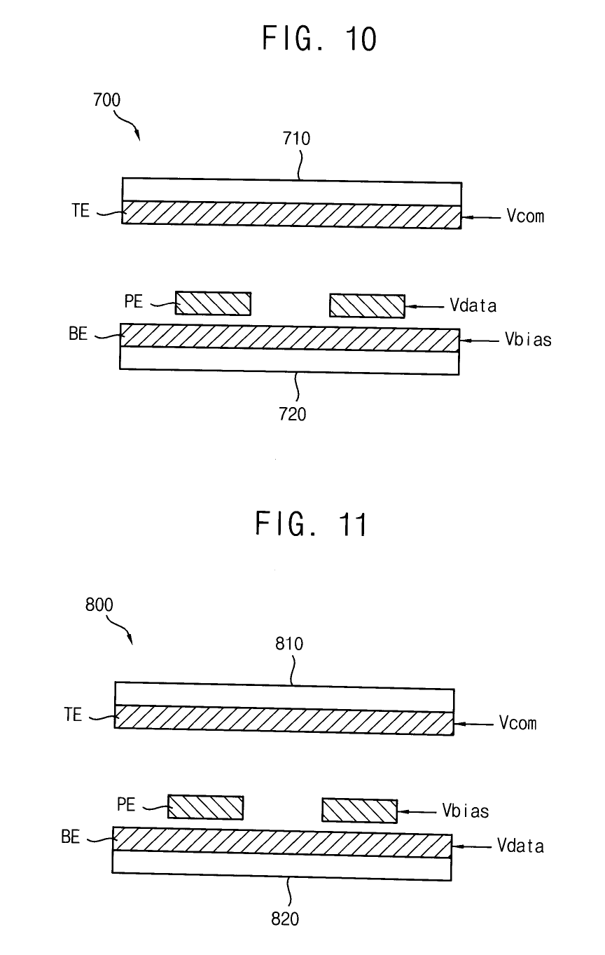

FIG. 10 is a conceptual diagram illustrating an alternative exemplary embodiment of a method of driving a display panel, according to the invention.

Referring to FIG. 10, an exemplary embodiment of the display panel 700 may include a first substrate 710 and a second substrate 720.

The first substrate 710 includes a top electrode TE. In such an embodiment, the top electrode TE receives a common voltage Vcom. The top electrode TE may be a common electrode which covers all pixel areas.

The second substrate 720 includes a bottom electrode BE and a pattern electrode PE that overlaps the bottom electrode BE. In such an embodiment, the bottom electrode BE receives a bias voltage Vbias, and the pattern electrode PE, that is, a pixel electrode receives a data voltage Vdata. The bottom electrode BE may be separately provided in each pixel area. The pattern electrode PE may be separately provided in each pixel area.

In an exemplary embodiment, a method of driving the display panel 700 shown in FIG. 10 may be the substantially same as the method of driving the display panel described referring to FIGS. 3 and 8.

In one exemplary embodiment, for example, as the described referring to FIG. 8, when the data voltage +Vdata of the positive polarity is applied to the pattern electrode PE of the pixel, the bias voltage +Vbias of the positive polarity is applied to the bottom electrode BE that overlaps the pattern electrode PE. When the data voltage −Vdata of the negative polarity is applied to the pattern electrode PE of the pixel, the bias voltage −Vbias of the negative polarity is applied to the bottom electrode BE.

FIG. 11 is a conceptual diagram illustrating another alternative exemplary embodiment of a method of driving a display panel, according to the invention.

Referring to FIG. 11, an exemplary embodiment of the display panel 800 may include a first substrate 810 and a second substrate 820.

The first substrate 810 includes a top electrode TE. In such an embodiment, the top electrode TE receives a common voltage Vcom. The top electrode TE may be a common electrode which covers all pixel areas.

The second substrate 820 includes a bottom electrode BE and a pattern electrode PE that overlaps the bottom electrode BE. In such an embodiment, the bottom electrode BE, which is a pixel electrode, receives a data voltage Vdata, and the pattern electrode PE receives a bias voltage Vbias. In such an embodiment, the bottom electrode BE may be separately provided in each pixel area. The pattern electrode PE may be separately provided in pixel area.

In an exemplary embodiment, a method of driving the display panel 800 shown in FIG. 11 may be the substantially same as the method of driving the display panel described referring to FIGS. 3 and 8.

In one exemplary embodiment, for example, as the described referring to FIG. 8, when the data voltage +Vdata of the positive polarity is applied to the bottom electrode BE of the pixel, the bias voltage +Vbias of the positive polarity is applied to the pattern electrode PE that overlaps the pattern electrode PE. When the data voltage −Vdata of the negative polarity is applied to the bottom electrode BE of the pixel, the bias voltage −Vbias of the negative polarity is applied to the pattern electrode PE.

According to exemplary embodiments of the invention, as described herein, the bias voltage is continually applied to the display panel such that the vertical field is formed together with the in-plane field during a period during which the display panel displays the image. Thus, the in-plane field may be formed in the vertical field such that the display panel may have a high-speed response time. In such embodiments, the polarity of the bias voltage swings in synchronization with the polarity of the data voltage based on the polarity inversion mode and thus, a degradation of the liquid crystal may be effectively prevented.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a display panel, the method comprising:
applying a common voltage and a bias voltage to two of a first electrode, a second electrode and a third electrode of the display panel to form a vertical field during a period during which the display panel displays an image; and
applying a data voltage based on a grayscale of the image to one of the first and second electrodes to form an in-plane field during the period during which the display panel displays the image,
wherein the display panel comprises:
a first substrate comprising the first electrode, the second electrode which overlaps the first electrode, and a transistor connected to one of the first and second electrodes; and
a second substrate disposed opposite to the first substrate and comprising the third electrode.

2. The method of claim 1, wherein
the applying the common voltage and the bias voltage to two of the first electrode, the second electrode and the third electrode of the display panel comprises applying the common voltage to the first electrode, and applying the bias voltage to the third electrode such that the vertical field is formed between the first and third electrodes, and
the applying the data voltage based on the grayscale of the image to one of the first and second electrodes comprises applying the data voltage to the second electrode such that the in-plane field is formed between the first and second electrodes.

3. The method of claim 2, wherein
the first electrode is a common electrode which substantially covers the first substrate.

4. The method of claim 1, wherein
the applying the common voltage and the bias voltage to two of the first electrode, the second electrode and the third electrode of the display panel comprises applying the bias voltage to the first electrode, and applying the common voltage to the third electrode such that the vertical field is formed between the first and third electrodes, and
the applying the data voltage based on the grayscale of the image to one of the first and second electrodes comprises applying the data voltage to the second electrode such that the in-plane field is formed between the second and third electrodes.

5. The method of claim 4, wherein
the third electrode is a common electrode which substantially covers the second substrate.

6. The method of claim 1, further comprising:
swinging a polarity of the data voltage every preset period based on a polarity inversion mode.

7. The method of claim 6, further comprising:
swinging a polarity of the bias voltage in synchronization with the polarity of the data voltage.

8. A display apparatus comprising:
a display panel comprising:
a first substrate which comprises a first electrode, a second electrode overlapping with the first electrode, and a transistor connected to one of the first and second electrode;
a second substrate which comprises a third electrode and is opposite to the first substrate; and
a liquid crystal layer disposed between the first and second substrates; and
a panel driving part configured to apply a common voltage and a bias voltage to two of the first, second and third electrodes to form a vertical field during a period during which the display panel displays an image and to apply a data voltage based on a grayscale of the image to one of the first and second electrodes to form an in-plane field during the period during which the display panel displays the image.

9. The display apparatus of claim 8, wherein
the common voltage is applied to the first electrode, and the bias voltage is applied to the third electrode such that the vertical field is formed between the first and third electrodes, and
the data voltage is applied to the second electrode such that the in-plane field is formed between the first and second electrodes

10. The display apparatus of claim 9, wherein
the first electrode is a common electrode which substantially covers the first substrate.

11. The display apparatus of claim 8, wherein
the bias voltage is applied to the first electrode, and the common voltage is applied to the third electrode such that the vertical field is formed between the first and third electrodes, and
the data voltage is applied to the second electrode such that the in-plane field is formed between the second and third electrodes.

12. The display apparatus of claim 11, wherein
the third electrode is a common electrode which substantially covers the second substrate.

13. The display apparatus of claim 8, wherein
the panel driving part is further configured to swing a polarity of the data voltage every preset period based on a polarity inversion mode.

14. The display apparatus of claim 13, wherein
the panel driving part is further configured to swing a polarity of the bias voltage in synchronization with the polarity of the data voltage.

15. The display apparatus of claim 8, wherein the display panel further comprises:
a first polarizing plate disposed adjacent to the first substrate and having a first polarization axis; and
a second polarizing plate disposed adjacent to the second substrate and having a second polarization axis.

16. The display apparatus of claim 15, wherein
a rubbing direction of the display panel is different from the first and second polarization axes, and
the display panel displays a white grayscale in a field-off state.

17. The display apparatus of claim 16, wherein
the rubbing direction of the display panel is substantially parallel to a predetermined direction.

18. The display apparatus of claim 15, wherein
a rubbing direction of the display panel is substantially parallel to at least one of the first and second polarization axes, and
the display panel displays a black grayscale in a field-off state.

19. The display apparatus of claim 18, wherein
the rubbing direction is sloped at an angle of about zero degree to about 90 degrees from the predetermined direction.

20. The display apparatus of claim 19, wherein
when the display panel displays a white grayscale, a longitudinal-axis direction of a liquid crystal in the liquid crystal layer is sloped at an angle of about 45 degrees from the first and second polarization axes.
